(19) United States
(12) Patent Application Publication
(10) Pub. No.: US 2019/0363365 A1
(43) Pub. Date: Nov. 28, 2019

(54) SOLID-STATE BATTERY STRUCTURE

(71) Applicant: Li Xiang Chen, Taipei (TW)

(72) Inventor: Li Xiang Chen, Taipei (TW)

(21) Appl. No.: 15/985,711

(22) Filed: May 22, 2018

(51) Int. Cl. H01M 4/66; H01M 4/04; H01M 10/0525

(52) U.S. Cl. CPC H01M 4/663; H01M 4/0407; H01M 10/0525; H01M 4/0423; H01M 4/0428

(57) ABSTRACT

A solid-state battery structure at least comprises a positive electrode layer, a solid electrolyte charged-ion permeable layer and a negative electrode layer, wherein the positive and negative electrode layers are respectively disposed on the opposite surfaces of the solid electrolyte charged-ion permeable layer. The positive electrode layer includes, in sequence from bottom to top, a positive electrode current collector layer, a complex ionic oxide layer, a graphene layer, and a positive electrode ion material layer; the negative electrode layer includes, in sequence from bottom to top, a negative electrode ion material layer, a graphene layer, a complex ionic oxide layer, and a negative electrode current collector layer. Each of the above-described layer structures is formed by coating or plating, and sequentially stacked after reaching a predetermined thickness, which constitutes a whole new solid-state battery.

### BACKGROUND OF INVENTION

### 1. Field of the Invention

The present invention relates generally to a solid-state battery, and more particularly to a solid-state secondary battery.

### 2. Description of Related Art

Lithium-ion secondary batteries or lithium-ion batteries have attracted much attention, and have been widely used in various electronic products such as notebook computers and mobile phones. In secondary batteries, the reactions to generate electrons and consume electrons are mostly reversible reactions. Therefore, these batteries can be electrochemically cycled between the charged state and the discharged state.

Portable electronic devices have been developed toward miniaturization and light weight, and their performance has also been greatly improved. Therefore, there is a need to develop rechargeable lithium batteries or secondary lithium batteries that are cost-effective and have high energy density and high output. In addition, especially in a high-temperature environment, after storage and a certain number of cycles, some lithium batteries may generate gas, which will reduce the life of the lithium battery. Therefore, it is necessary to provide a robust battery cell that can prolong its service life for application in the field of thin film lithium batteries.

However, on the one hand, traditional lithium batteries are difficult to miniaturize; on the other hand, liquid organic electrolytes are toxic to the environment and the human body. The use of liquid electrolytes for long periods of time is prone to liquid leakage, and even to combustion or explosion, which greatly jeopardizes safety.

Therefore, overcoming the bottleneck in traditional lithium battery process technology has become an important issue. At present, the industry has continuously conducted relevant technical studies to break the technological bottleneck and effectively increase its volumetric energy density and safety. Therefore, how to make a whole new solid-state battery to effectively improve the shortcoming of conventional lithium battery has become an urgent issue.

### SUMMARY OF THE INVENTION

The primary objective of the present invention is to provide a solid-state battery structure that can solve the problem of the volumetric energy density of lithium batteries of the prior art unable to be effectively improved, and at the same time replace the traditional liquid electrolyte with a solid electrolyte to achieve a more secure solid-state battery.

The secondary objective of the present invention is to provide a solid-state battery structure that can effectively improve energy density, cycle life, and improve safety and reliability and high temperature resistance.

Another objective of the present invention is to provide a solid-state battery that has a good mobility of charged ions to greatly enhance the overall conductivity and the power storage property.

According to all the objects of the present invention, a whole new solid-state battery structure is proposed, which comprises at least a positive electrode layer, a solid electrolyte charged-ion permeable layer and a negative electrode layer, wherein the positive and negative electrode layers are respectively disposed on the opposite surfaces of the solid electrolyte charged-ion permeable layer. The positive electrode layer includes, in sequence from bottom to top, a positive electrode current collector layer, a complex ionic oxide layer, a graphene layer, and a positive electrode ion material layer. The negative electrode layer includes, in sequence from bottom to top, a negative electrode charged-ion material layer, a graphene layer, a complex ionic oxide layer, and a negative electrode current collector layer. Each of the above-described layer structures is formed by coating or plating, and sequentially stacked after reaching a predetermined thickness.

The implementation methods, according to the solid-state battery structure proposed in the present invention, include forming a coating or plating by any method of the Chemical Vapor Deposition (CVD), Physical Vapor Deposition (PVD), or Plasma Enhanced Chemical Vapor Deposition (PECVD).

### BRIEF DESCRIPTION OF THE DRAWINGS

FIG. 1 shows a schematic diagram of a better embodiment of a solid-state battery.

### DETAILED DESCRIPTION OF THE INVENTION

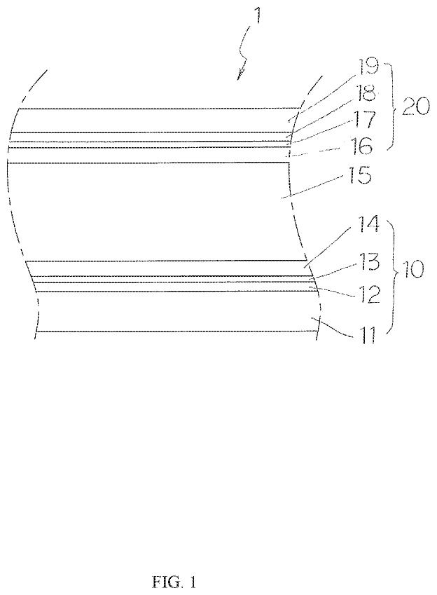

Referring to FIG. 1, a schematic diagram of an embodiment of a solid-state battery is disclosed. As shown in the FIGURE, the composition of the solid-state battery 1 comprises at least a positive electrode layer 10, a negative electrode layer 20, and a solid electrolyte charged-ion permeable layer 15.

The positive electrode layer 10 further comprises a positive electrode ion material layer 11, a graphene layer 12, a complex ionic oxide layer 13, and a positive electrode current collector layer 14. The negative electrode layer 20 further comprises a negative electrode charged-ion material layer 16, a graphene layer 17, a complex ionic oxide layer 18 and a negative electrode current collector layer 19.

In one embodiment, the positive electrode collector layer 14 and the negative electrode collector layer 19 themselves is to provide electrons as the conductors during charge and discharge of the battery. In choosing the material in one embodiment, the positive electrode current collector layer 14 is mainly aluminum foil, and the negative electrode current collector layer 24 is mainly copper foil.

In one embodiment, the positive electrode ion material layer 11 and the complex ionic oxide layer 13 in the positive electrode layer 10 are positive electrode composite materials having charge and discharge performance, and may be selected from any of lithium cobaltate, lithium manganate, and lithium nickelate, so that they have a long cycle life, excellent safety performance, good high temperature performance and relatively low price.

In one embodiment, the graphene layers 12 and 17 are an ultra-thin network structure made of carbon atoms, so the migration of charged ions is little limited. Therefore, they have very good mobility to allow the charged ions in the graphene layers 12, 17 to achieve near-light speed motion, making the overall electrical conductivity and power storage property greatly improved.

In one embodiment, the solid electrolyte charged-ion permeable layer 15 is a polymer. In one embodiment, a ceramic solid electrolyte is used to replace the electrolyte as an intermediate isolation layer between the positive electrode layer 10 and the negative electrode layer 20. The solid electrolyte charged-ion permeable layer 15 has channels for rapid migration of charged ions with a higher conductivity, and because of the solid-state type there are restrictions on the shape and thickness.

In one embodiment, the negative electrode charged-ion material layer 16 and the complex ionic oxide layer 18 in the negative electrode layer 20 are negative electrode composite materials having charge and discharge performance, and may be selected from any of carbon, silicon or titanium to improve electric capacity and service life, and enhance the overall performance of lithium batteries.

The solid-state battery 1 of the present invention is fabricated by forming a coating or plating by any method of the Chemical Vapor Deposition (CVD), Physical Vapor Deposition (PVD), or Plasma Enhanced Chemical Vapor Deposition (PECVD).

Every layer of solid-state battery 1 provided in the present invention, in an embodiment, is sequentially implemented by stacking a predetermined thickness, so as to constitute a safe, lightweight, high energy density and high-cycle innovative secondary battery. Through the aforementioned stacking regulation, a positive electrode current collector layer 11 may be selected as a base layer, or a negative electrode current collector layer 19 may be selected as a base layer, in order layer-by-layer to complete the stacking process by coating or plating to form a whole solid-state battery 1. The specific implementation sequence is as follows:

In the first embodiment, the stacking sequence of each layer using the positive electrode current collector layer 11 as a base layer and selecting a coating or plating method is as follows: the positive electrode current collector layer 11 serves as a base layer; the complex ionic oxide layer 12 is laminated on the surface of the positive electrode current collector layer 11; the graphene layer 13 is laminated on the surface of the complex ionic oxide layer 12; the positive electrode ion material layer 14 is laminated on the surface of the graphene layer 13; the solid electrolyte charged-ion permeable layer 15 is laminated on the surface of the positive ion material layer 14; the negative electrode charged-ion material layer 16 is laminated on the surface of the solid electrolyte charged-ion permeable layer 15; the graphene layer 17 is laminated on the surface of the negative electrode charged-ion material layer 16; the complex ionic oxide layer 18 is laminated on the surface of the graphene layer 17; the negative electrode current collector layer 19 is laminated on the surface of the complex ionic oxide layer 18.

In the second embodiment, the stacking sequence of each layer using the negative electrode current collector layer 19 as a base layer and selecting a coating or plating method alike is as follows: the negative electrode current collector layer 19 serves as a base layer; the complex ionic oxide layer 18 is laminated on the surface of the negative electrode current collector layer 19; the graphene layer 17 is laminated on the surface of the complex ionic oxide layer 18; the negative electrode charged-ion material layer 16 is laminated on the surface of the graphene layer 17; the solid electrolyte charged-ion permeable layer 15 is laminated on the surface of the negative electrode charged-ion material layer 16; the positive electrode ion material layer 14 is laminated on the surface of the solid electrolyte charged-ion permeable layer 15; the graphene layer 13 is laminated on the surface of the positive electrode ion material layer 14; the complex ionic oxide layer 12 is laminated on the surface of the graphene layer 13; the positive electrode current collector layer 11 is laminated on the surface of the complex ionic oxide layer 12.

The solid-state battery of the present invention is made with a completely new solid electrolyte charged-ion permeable layer as an intermediate layer, in particular adopting a ceramic solid electrolyte, both sides of which comprise a positive electrode layer and a negative electrode layer, respectively, to constitute a complete solid-state battery structure. From the above description, it can be known that the present invention on the one hand can effectively improve the high energy density, cycle life, high safety performance, and high temperature resistance of the battery. Particularly, the graphene layer can provide good mobility of charged ions to allow electrons in the graphene layer to achieve the speed of near-light speed and greatly improve the overall conductivity and power storage capacity.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

1. A solid-state battery structure is made mainly by stacking a predetermined thickness for forming a next layer and adopting a stacking sequence from bottom to top, and the composition comprises:
a positive electrode current collector layer;
a complex ionic oxide layer laminated on the surface of the positive electrode current collector layer;
a graphene layer laminated on the surface of complex ionic oxide layer;
a positive electrode ion material layer laminated on the surface of graphene layer;
a solid electrolyte charged-ion permeable layer laminated on the surface of positive electrode ion layer;
a negative electrode charged-ion material layer laminated on the surface of solid electrolyte charged-ion permeable layer;
a graphene layer laminated on the surface of negative electrode charged-ion material layer;
a complex ionic oxide layer laminated on the surface of graphene layer;
a negative electrode current collector layer laminated on the surface of complex ionic oxide layer.

2. A solid-state battery structure is made mainly by stacking a predetermined thickness for forming a next layer and adopting a stacking sequence from bottom to top, and the composition comprises:
a negative electrode current collector layer;
a complex ionic oxide layer laminated on the surface of negative electrode current collector layer;
a graphene layer laminated on the surface of complex ionic oxide layer;
a negative electrode charged-ion material layer laminated on the surface of graphene layer;
a solid electrolyte charged-ion permeable layer laminated on the surface of negative electrode ion material layer;
a positive electrode ion material layer laminated on the surface of solid electrolyte charged-ion permeable layer;
a graphene layer laminated on the surface of positive electrode ion material layer, a complex ionic oxide layer laminated on the surface of graphene layer;
a. positive electrode current collector layer laminated on the surface of complex ionic oxide layer.

3. The structure defined in claim 1, wherein all layers are made by forming a coating or plating structure by any method of the Chemical Vapor Deposition (CVD), Physical Vapor Deposition (PVD), or Plasma Enhanced Chemical Vapor Deposition (PECVD).

4. The structure defined in claim 2, wherein all layers are made by forming a coating or plating structure by any method of the Chemical Vapor Deposition (CVD), Physical Vapor Deposition (PVD), or Plasma Enhanced Chemical Vapor Deposition (PECVD).
